(19) United States
(12) Patent Application Publication
(10) Pub. No.: US 2015/0286779 A1
(43) Pub. Date: Oct. 8, 2015

(54) SYSTEM AND METHOD FOR EMBEDDING A PHYSIOLOGICAL SIGNAL INTO A VIDEO

(71) Applicant: Xerox Corporation, Norwalk, CT (US)

(72) Inventors: Raja BALA, Pittsford, NY (US); Lalit Keshav MESTHA, Fairport, NY (US); Beilei XU, Penfield, NY (US); Edgar A. BERNAL, Webster, NY (US)

(73) Assignee: Xerox Corporation, Norwalk, CT (US)

(21) Appl. No.: 14/245,353

(22) Filed: Apr. 4, 2014

(51) Int. Cl. G06F 19/00; G11B 27/036; H04N 5/265; H04N 19/46

(52) U.S. Cl. CPC G06F 19/321; H04N 19/46; G11B 27/036; H04N 5/265

(57) ABSTRACT

What is disclosed is a system and method for embedding a time-varying physiological signal corresponding to a physiological function of a subject into a video. In one embodiment, a video of a subject is received along with a time-varying signal corresponding to a physiological function of the subject. A representative image is obtained from the video. The received time-varying signal is divided into a plurality of signal segments. The obtained image is repeatedly replicated to generate a video sequence. The signal segments are encoded in the images comprising the generated video sequence. The video sequence containing the encoded physiological signal is then compressed using a video compression technique.

### TECHNICAL FIELD

The present invention is directed to systems and methods for embedding a time-varying physiological signal corresponding to a physiological function of a subject into a video of that subject.

### BACKGROUND

Estimating health vitals for a patient such as, for instance, heart rate and blood pressure using non-contact video imaging has gained much attention in the field of mobile health monitoring wherein a camera built into a laptop, tablet or smartphone is used to capture a video of a patient and the video is then communicated to a remote medical lab or facility where the received video is analyzed and processed to extract a patient's vitals. Issues arise in this scenario. For example, video files tend to be large and may stress a bandwidth-limited network in rural areas and under-developed countries where network infrastructure is either lacking or is in the process of being installed and/or upgraded. Secondly, once a physiological signal for the subject has been estimated from a video, it is desirable to bind that signal to the original video for future access. Moreover, healthcare guidelines require that a patient's identity and medical information be protected. As such, a video of that patient needs to be encrypted and/or redacted during transmission to obscure the identity of the patient. Methods are needed in this art for securely encoding a physiological signal corresponding to a patient's health vitals into the video or an image such that the video or image can be efficiently compressed for transmission and/or storage while protecting the patient's privacy.

Accordingly, what is needed in this art are sophisticated systems and methods for embedding a time-varying physiological signal corresponding to a physiological function of a subject into a video of that subject.

### BRIEF SUMMARY

What is disclosed is a system and method for embedding a time-varying physiological signal corresponding to a physiological function of a subject into a video. In one embodiment, a video of a subject is received along with a time-varying signal corresponding to a physiological function of the subject. A representative image is obtained from the video. The received time-varying signal is divided into a plurality of signal segments. The obtained representative image is repeatedly replicated. The signal segments are encoded into each respective replicated image. Thereafter, the replicated images are processed to generate a video sequence. The video sequence comprising the replicated images containing the encoded signal segments is then compressed using a video compression technique.

Features and advantages of the above-described method will become readily apparent from the following detailed description and accompanying drawings.

### BRIEF DESCRIPTION OF THE DRAWINGS

The foregoing and other features and advantages of the subject matter disclosed herein will be made apparent from the following detailed description taken in conjunction with the accompanying drawings, in which:

FIG. 1 shows a video camera actively capturing a video of an anterior thoracic region of subject;

FIG. 2 shows a representative image (frame #2) being obtained from the video captured by the video camera of FIG. 1;

FIG. 3 shows the representative image of FIG. 2 with a rubber-band box having been drawn various areas of interest in that image;

FIG. 4 shows an example continuous physiological signal corresponding to a physiological (cardiac) function for the subject of FIG. 1;

FIG. 5 shows the signal segment of the physiological signal of FIG. 4 corresponding to the time interval T=0 to T=1 unit of time having been encoded into a patch of pixels;

FIG. 6 shows the patch of pixels FIG. 5 which encodes a first signal segment replacing original pixels in the selected area of FIG. 3 to obscure the subject's identity;

FIG. 7 is a flow diagram which illustrates one example embodiment of the present method for embedding a physiological signal into a video;

FIG. 8 is a continuation of the flow diagram of FIG. 7 with flow processing continuing with respect to node A; and

FIG. 9 illustrates one example embodiment of a networked system for implementing various aspects of the present method as described with respect to the flow diagrams of FIGS. 7 and 8.

### DETAILED DESCRIPTION

What is disclosed is a system and method for embedding a time-varying physiological signal corresponding to a physiological function of a subject into a video.

### Non-Limiting Definitions

A “subject” refers to a living person or patient. Although the term “person” or “patient” may be used throughout this text, it should be appreciated that the subject may be something other than human. As such, use of such terms is not to be viewed as limiting the scope of the appended claims strictly to humans.

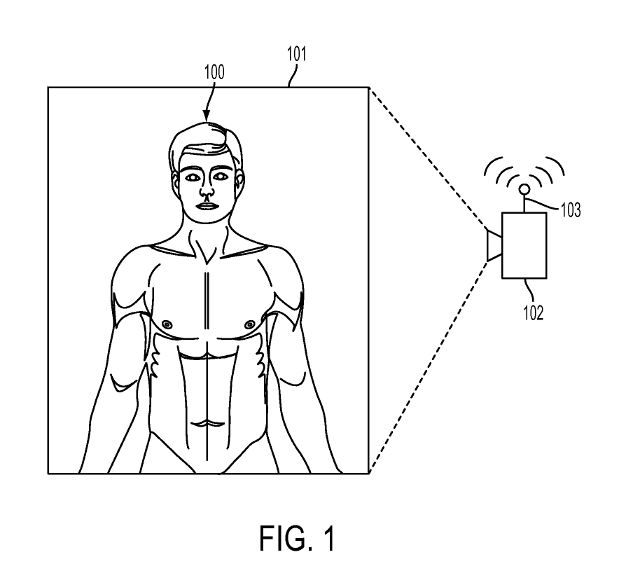

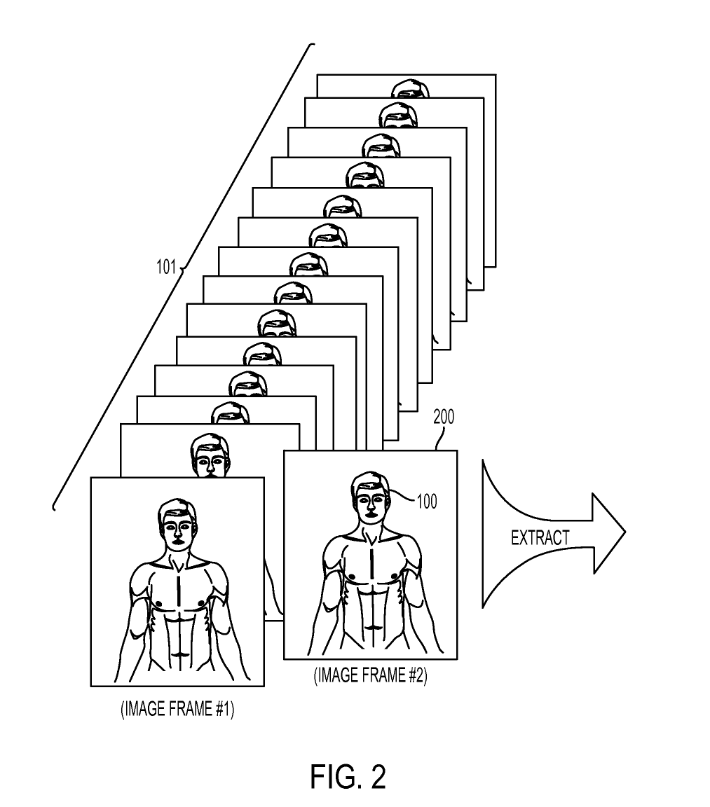

A “video” refers to a plurality of time-sequential frames of images captured by a video camera, as is generally understood. Each image in the video is an array of pixels normally arranged on a grid. For ease of explanation, we refer herein to the case where each video frame comprises a single channel. However, multichannel (e.g. RGB color) video representations are also comprehended. The intensity of each pixel depends on the characteristics of the subject, lighting conditions, and sensitivity of the camera used to capture or measure that pixel. The resolution of the video camera depends on the number of detectors (typically photodetectors) in the camera's imaging sensor. FIG. 1 shows a video camera 102 actively capturing a video 101 of an anterior thoracic region of a subject 100. The video is communicated to a remote device via a wireless element 103, shown as an antenna for illustrative purposes. The images of the video are more fully shown in FIG. 2.

“Receiving a video” is intended to be widely construed and includes: retrieving, capturing, downloading, obtaining, or otherwise acquiring a video for processing in accordance with the teachings hereof. FIG. 2 shows a portion of the video 101 captured using the video camera 102 of FIG. 1. The video may be downloaded from a remote device over a network. The video may be retrieved from a media or obtained from a web-based application which makes videos available for processing. The video may also be retrieved from a handheld device such as a smartphone, tablet, or laptop. The video may be retrieved directly from a memory or storage device of the video camera used to capture that video.

“Obtaining a representative still image” means to extract or otherwise obtain at least one image from the video for processing. FIG. 2 shows one representative image (frame #2 at 200) being extracted from the video 101. A representative image may be obtained using a variety of techniques. For example, a representative image may be manually identified by a user watching the video on a display device and selecting the representative image. A representative image may be automatically identified in the video using for example, a facial detection algorithm, a facial recognition algorithm, an object detection algorithm, or an object identification algorithm or software tool. What defines a particular representative image for processing will depend on the system wherein the methods disclosed herein find their intended implementations. In general, it is preferable to extract the best representation of the patient image with a fontal pose, good contrast, focus, and sharpness, and the absence of artifacts such as motion blur, shadows, etc. The identified representative image is repeatedly replicated, and at least one signal segment of a received physiological signal is encoded in each replicated image until all signal segments have been encoded. The image wherein a signal segment is encoded may comprise a composite image generated from a plurality of images. The images wherein signal segments are encoded create a video sequence.

A “video sequence”, as used herein, refers to a sequence of images. Methods for generating a video from individual images are well established in the video processing arts. The generated video sequence may include one or more images which do not have a signal segment encoded therein. Moreover, the video sequence may include images that are different than the images containing the signal segments. The video sequence may further have metadata such as a header or trailer added thereto. The metadata fields may include relevant information such as, for example, patient name, age, medical records, time, date, location, and the like.

“Selecting a location” means to identify at least one area of interest in the representative image wherein one or more signal segments are to be encoded. This can be effectuated using any of a variety of techniques such as, pixel classification, object identification, facial recognition, color, texture, spatial features, pattern recognition, motion detection, foreground segmentation, and a user input. Original pixels of the selected location in the representative image are replaced by pixel patches which encode respective signal segments. In one implementation, it may be highly desirable to obscure the identity of the subject in the image. In this embodiment, the selected location would be a facial area of the subject. A facial detection software algorithm can be utilized to automatically identify and isolate pixels in the obtained representative image which form the facial area of the subject. Signal segments would then be embedded in pixel patches which, in turn, are used to replace the original pixels in the facial area. In such a manner, the subject's identity in the representative image is effectively obscured via pixilation. It may be desirable to obscure only the subject's eyes in the representative image. They may be effectuated by manually or automatically selecting that particular area in the obtained representative image. Original pixels corresponding to the subject's eyes would then be replaced by the patches of pixels encoding various signal segments. It may also be desirable to encode a signal segment in an area of interest in the representative image which is something other than the subject's face such as, for instance, a background area such as a wall or sky, an object in the image, a section of clothing worn by the subject, an area of exposed skin such as a chest area, an area of a particular color, or a border of the image, to name a few.

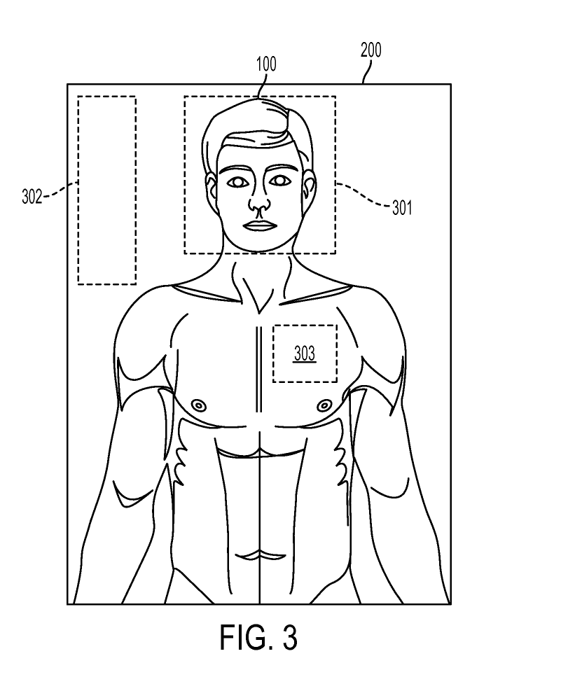

In other embodiments, the obtained representative still image is displayed on a display device of a workstation and a user/operator thereof manually selects the region of the representative image where patches of pixels encoding the signal segments are to be placed. This can be effectuated by using a mouse, for instance, to draw a rubber-band box over a desired area in the image and selecting or otherwise identifying that particular area for encoding. FIG. 3 shows the obtained representative image 200 of FIG. 2 with a rubber-band box 301 having been manually (or automatically) drawn around the head and face of the subject. In this example, the original pixels in the representative image of the selected area of interest encompassed by the boundaries of the rubber-band box 301 are replaced by a patch of pixels which encode one or more signal segments. In one embodiment, the encoding is done in a visible manner. For example, the encoding in the selected location 301 could be designed to obscure the identity of the subject. Alternatively, location 302 is selected as an area of interest comprising a solid background wherein pixel patches which encode signal segments are to be placed. Selected location 303 shows an area of exposed skin on the subject's chest where pixel patches encoding signal segments are to be placed. Signal segments of differing lengths may be embedded in different locations in a single representative image or at different locations across successive images. Alternatively, pixels in the selected location are removed from the representative image and those pixels are re-arranged to effectively encode the signal segments. Those pixels are then placed back into the representative image in their re-arranged form. In another embodiment, the encoding is done in an invisible, or visually subtle manner. For example, the information could be embedded in spatial frequencies that are not visually perceived.

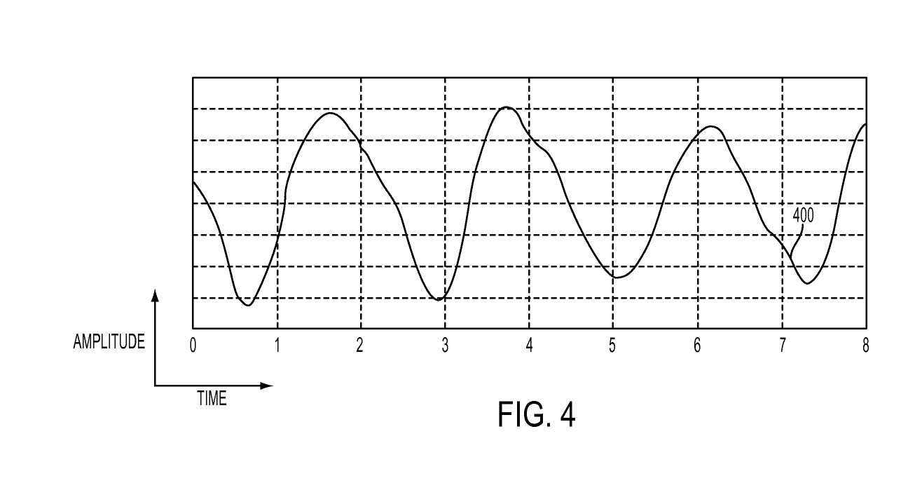

A “physiological signal” is a time-varying signal which corresponds to a physiological function of the subject. If the physiological function is a cardiac function then the time-varying physiological signal is a cardiac signal that corresponds to the subject's cardiac function. FIG. 4 shows an example of a continuous physiological signal 400 corresponding to a cardiac function of the subject of FIG. 1. The time-varying signal of FIG. 4 has an example temporal duration of 8 units of time. If the physiological function is a respiratory function then the time-varying physiological signal is a respiratory signal that corresponds to the subject's respiratory function. The received time-varying physiological signal may have been obtained from the received video. The received signal may be spatio-temporal signal, meaning the signals are generated in a localized region in the body comprising of identity of the region where it is being generated from. For example, respiratory signals generated on the chest surface between the left and right sides of the thoracic cage. The following US patent applications, which are incorporated in their entirety by reference, teach various aspects of extracting a physiological signal from a video. “A Video Acquisition System And Method For Monitoring A Subject For A Desired Physiological Function”, U.S. patent application Ser. No. 13/921,939, by Xu et al. “Processing Source Video For Real-Time Enhancement Of A Signal Of Interest”, U.S. patent application Ser. No. 13/745,283, by Tanaka et al. “Filtering Source Video Data Via Independent Component Selection”, U.S. patent application Ser. No. 13/281,975, by Mestha et al. If camera-related noise or other environmental factors affecting video capture are present, compensation can be introduced as described in: “Removing Environment Factors From Signals Generated From Video Images Captured For Biomedical Measurements”, U.S. patent application Ser. No. 13/401,207, by Mestha et al. The received time-varying signal may have been obtained from another video which is different than the video that was received. For instance, the received time-varying signal may have been generated by an instrument or medical device such as a EKG, ECG, MRI, CAT-SCAN, or PET-SCAN device, to name a few.

In accordance with the methods disclosed herein, the time-varying physiological signal is divided into equal-length signal segments or into segments which may vary in length. The length of the various signal segments may depend on a size of the neighborhood of pixels in the representative image where a given signal segment is to be encoded. The example time-varying physiological signal of FIG. 4 may be divided into segments of equal length wherein each segment has a temporal duration of 1 unit of time. Alternatively, the segment can be as long as the signal itself. The signal segments are then encoded into patches of pixels.

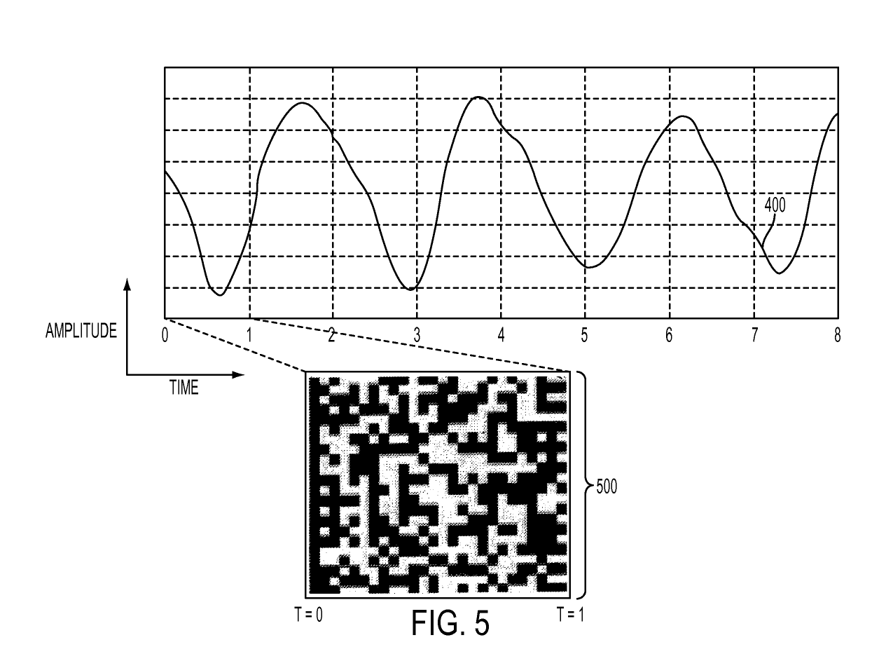

“Encoding a signal segment”. Methods for encoding signal segments into one or more patches of pixels can be effectuated using a variety of techniques which include spatial pixel replacement, manipulation of DCT coefficients, and seeking an optimal basis to encode the signal. A particular signal segment may be encoded into a patch of pixels which takes the form of a watermark or a barcode pattern. Various 2D barcode patterns enable efficient encoding in the form of a matrix of pixels. FIG. 5 shows the signal segment of the physiological signal 400 corresponding to time T=0 to T=1 unit of time having been encoded into a patch of pixels, collectively at 500. Any relation to an actual barcode of a product or service is entirely coincidental and unintentional.

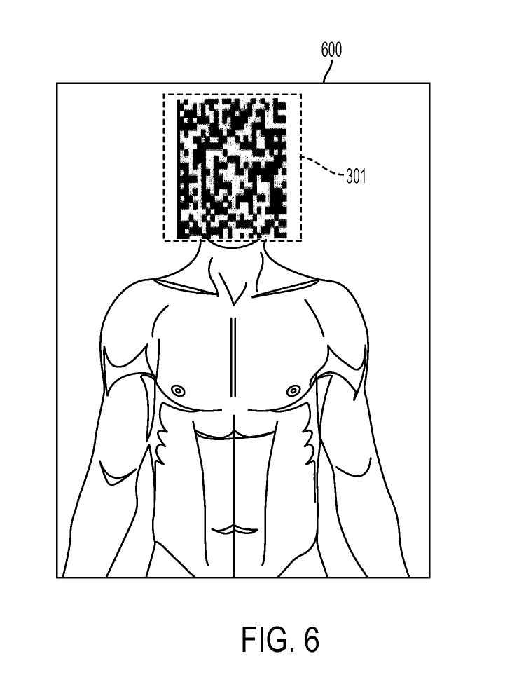

Once the signal segments have been encoded into patches of pixels, an equal-sized patch of original pixels at one or more locations in the representative image are replaced by the pixel patches. FIG. 6 shows a copy 600 of the representative image wherein the patch of pixels which encode the signal segment (as shown by way of example in FIG. 5) replace original pixels at the selected location 301 in the representative image. In other embodiments, original pixels in the representative image that were replaced by the pixel patches encoding the signal segments are recovered such that the original image can be reconstructed upon decoding. This can be effectuated, for example, by encoding the values of the original pixels and/or their locations into an audio channel of the generated video sequence. In some embodiments, it may be desirable to transform the time-varying physiological signal into an alternate domain (e.g., a domain in which the signal may be more highly compressible such as Fourier, discrete cosine, noiselet or wavelet domains) and then encoding segments of that transformed signal into patches of pixels which are placed into respective images. It may be desirable to construct a more highly compressible synthetic signal from the physiological signal and encode segments of that synthetic signal into pixel patches.

“Decoding a signal segment” means to identify the patch of pixels in a representative image wherein a signal segment is encoded, extracting that patch of pixels, and decoding the signal segment therefrom. Decoded signal segments can be stitched together to reconstruct the original physiological signal. In other embodiments, positional information such as (X₁, Y₁), (X₂, Y₂) location in the representative image where the patch of pixels encoding a signal segment is located along with any other information needed for decoding, may be preserved in alternative data fields, including the header, the trailer, metadata fields, and the audio channel of the generated video sequence so that it may subsequently be retrieved in advance of decoding. Other information may also be embedded in the representative image at one or more separate locations or, alternatively, placed in a header or a trailer frame or in the metadata associated with the video file as desired.

“Compressing a video” means to reduce the overall size of the video file. Methods for video compression are well established and include such techniques as: motion-compensation, transform-based, and entropy-based compression, including MPEG/H264 compression, adaptive Huffman methods, arithmetic encoding, and discrete cosine or wavelet-based methods. Since compression methods are well understood and offer different features and advantages, a further discussion as to one preferred method has been omitted. The end-user of the methods disclosed herein will choose one preferred compression method over others to suit their own needs.

### Flow Diagram of One Embodiment

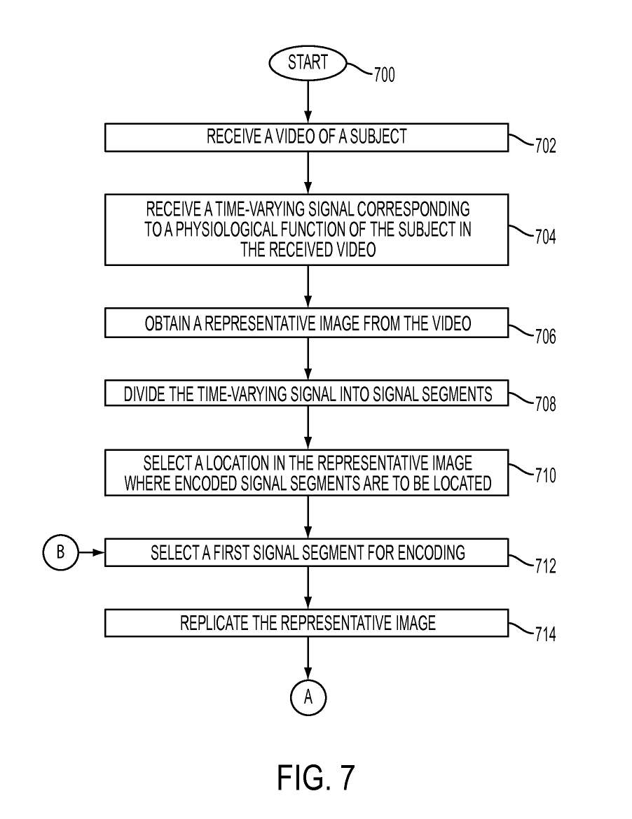

Reference is now being made to the flow diagram of FIG. 7 which illustrates one example embodiment of the present method for embedding a physiological signal into a video. Flow processing begins at 700 and immediately proceeds to step 702.

At step 702, receive a video of a subject for processing. The video was captured of a subject by a video camera such as the video camera 102 of FIG. 1. One example video is shown in FIG. 2.

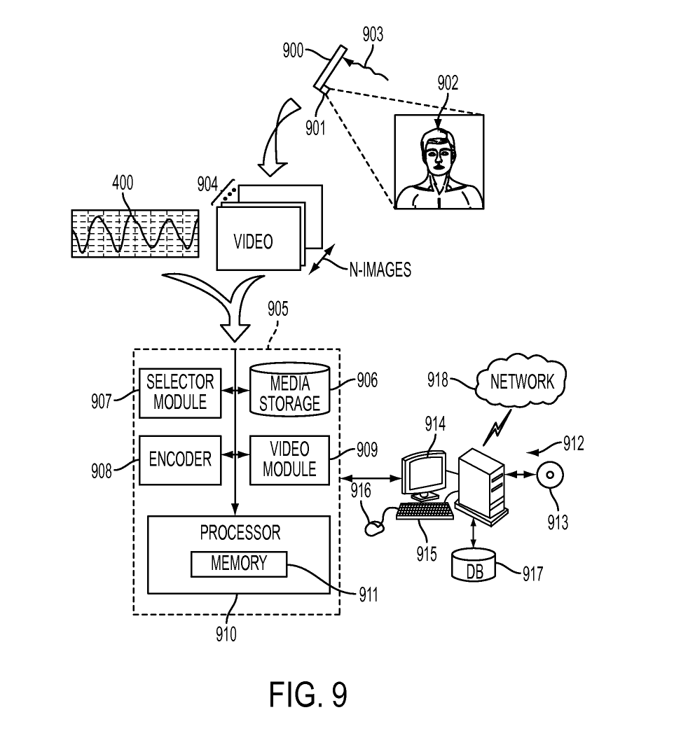

At step 704, receive a time-varying signal which corresponds to a physiological function of the subject in the received video. One example of a continuous time-varying physiological signal is shown and discussed with respect to FIG. 4. As discussed herein further with respect to FIG. 9, the video is received by a system which includes a processor capable of retrieving machine-readable program instructions from memory which, when executed by the processor, cause the processor to processing the received video and physiological signal in a manner disclosed herein.

At step 706, obtain a representative image from the video. FIG. 2 shows representative image (frame #2) being obtained from the received video. Software tools for obtaining one or more representative images from a video are widely available. The obtained representative image and the received video may be stored to a storage device or communicated to a remote device over a network.

At step 708, divide the time-varying signal into signal segments. Methods for dividing a continuous signal into a plurality of segments are well established in the signal processing arts.

At step 710, select a location in the representative image where encoded signal segments are to be located. For explanatory purposes, the selected location is facial area 301 as discussed with respect to FIG. 3.

At step 712, select a first signal segment for encoding. In this embodiment, the signal segments are all the same length. However, length of the signal segments does not have to be the same.

At step 714, replicate the representative image.

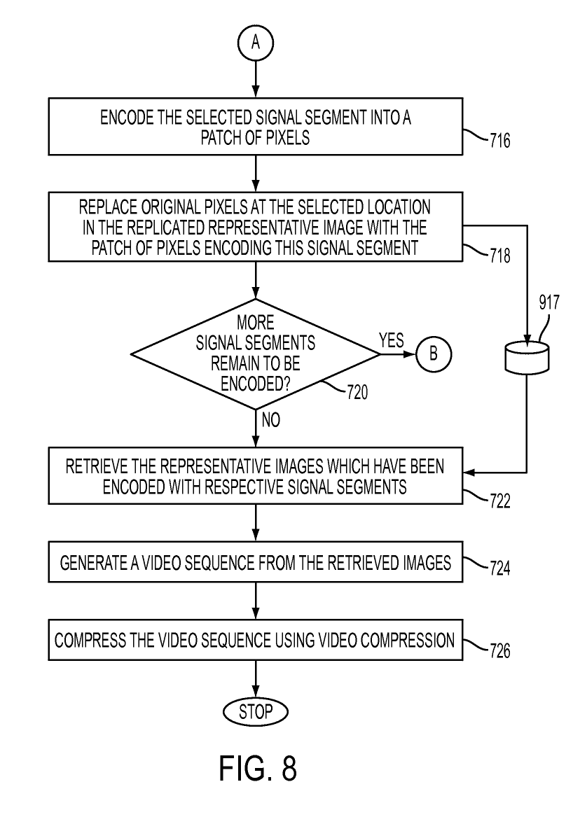

Reference is now being made to FIG. 8 which is a continuation of the flow diagram of FIG. 7 with flow processing continuing with respect to node A.

At step 716, encode the signal segment (selected in step 712) into a patch of pixels. An example patch of pixels encoding a signal segment is shown in FIG. 5.

At step 718, replace original pixels at the selected location in the replicated representative image (created in step 714) with the patch of pixels encoding this signal segment. FIG. 6 shows a patch of pixels encoding the first signal segment replacing the original pixels in the selected location 301. This replicated image is then stored to a memory or storage device. It should be appreciated that, on a first iteration, the patch of pixels encodes a first signal segment. On successive iterations, a next patch of pixels encodes a next signal segment, and so on, until no more signal segments remain to be encoded. Each successive patch of pixels replaces original pixels at the selected location in a next copy of the representative image.

At step 720, a determination is made whether more signal segments remain to be encoded. If so then processing continues with respect to node B wherein, at step 712, a next signal segment is selected for encoding. The next signal segment is encoded into a patch of pixels which, in turn, are used to replace the original pixels in the selected location in a next copy of the representative image. The copy of the representative image containing the encoded signal segment is stored to a storage device, such as storage 917 of FIG. 9. If no more signal segments remain to be encoded then processing continues with respect to step 722.

At step 722, retrieve the representative images which have been encoded with respective signal segments. The representative images are retrieved from storage device 917.

At step 724, generate a video sequence from the retrieved images.

At step 726, compress the video sequence using a video compression method. The compressed video sequence can then be stored to a storage device or communicated to a remote device over a network. Thereafter, in this embodiment, further processing stops. It should be appreciated that the flow diagrams depicted are illustrative and that one or more of the operative steps may be performed in a differing order. Operative steps may be added, modified, enhanced, or consolidated. Variations thereof are intended to fall within the scope of the appended claims.

### Example Networked System

Reference is now being made to FIG. 9 which illustrates one example embodiment of a networked system for implementing various aspects of the present method as described with respect to the flow diagrams of FIGS. 7 and 8. The embodiment shown is illustrative and should not be viewed as limiting the scope of the appended claims strictly to this configuration.

In FIG. 9, a handheld wireless device 900 is shown using video camera 901 to capture video of a patient 902 while also acquiring an audio signal thereof (shown as sound waves 903) using the device's built-in microphone. The video of the subject, collectively at 904 shown comprising N image frames, containing audio signals are communicated to the processing system 905, which may be internal to the handheld device 900. A time-varying physiological signal 400 that corresponds to the desired physiological function is also received. The video and the physiological signal are stored to storage device 906.

Selector Module 907 retrieves the stored video and selects at least one representative image for processing in accordance with the methods disclosed herein. Selector 907 further functions to facilitate a selection of a location within the representative image wherein the encoded signals are to be embedded. Encoder 908 retrieves a copy of the representative image along with the physiological signal from storage device 906 and divides the signal into a plurality of signal segments. The Encoder steps through the signal segments and proceeds to encode those segments into respective patches of pixels. The Encoder then replaces original pixels in a copy of each representative image with the patches of pixels at the location selected or otherwise identified by the Selector 908. As the representative images are successively encoded, they are stored to Media Storage 906. Once all the replicated representative images have been encoded, Video Module 909 retrieves the encoded representative images and generates a video sequence and proceeds to compress that video sequence using a video compression method. The compressed video sequence is communicated to Storage Device 906. Processor 910 retrieves machine-readable program instructions from Memory 911 and is provided to facilitate the functionality of any of the modules of the processing system 905. The processor, operating alone or in conjunction with other processors and memory, may be configured to assist or otherwise facilitate the functionality of any of the processors and modules of system 905.

Processing system 905 is shown in communication with a workstation 912. A computer case of the workstation houses various components such as a motherboard with a processor and memory, a network card, a video card, a hard drive capable of reading/writing to machine readable media 913 such as a floppy disk, optical disk, CD-ROM, DVD, magnetic tape, and the like, and other software and hardware needed to perform the functionality of a computer workstation. The workstation further includes a display device 914, such as a CRT, LCD, or touchscreen device, for displaying information, video, measurement data, computed values, medical information, results, locations, and the like. A user can view that information and make a selection from menu options displayed thereon. Keyboard 915 and mouse 916 effectuate a user input or selection. The workstation 912 implements a database in storage device 917 wherein patient records are stored, manipulated, and retrieved in response to a query. Such records, in various embodiments, take the form of patient medical history stored in association with information identifying the patient along with medical information. Although the database is shown as an external device, the database may be internal to the workstation mounted, for example, on a hard disk therein.

It should be appreciated that the workstation has an operating system and other specialized software configured to display alphanumeric values, menus, scroll bars, dials, slideable bars, pull-down options, selectable buttons, and the like, for entering, selecting, modifying, and accepting information needed for processing video and physiological signals in accordance with the teachings hereof. The workstation is further enabled to decompress the compressed video sequence and decode the encoded signal segments contained in the representative images comprising the video sequence. In other embodiments, a user or technician may use the user interface of the workstation to identify areas of interest, set parameters, select representative still images and/or regions of representative images for processing. These selections may be stored/retrieved in storage devices 913 and 917. Default settings and initial parameters can be retrieved from any of the storage devices shown, as needed.

Although shown as a desktop computer, it should be appreciated that the workstation 912 can be a laptop, mainframe, or a special purpose computer such as an ASIC, circuit, or the like. The embodiment of the workstation of FIG. 9 is illustrative and may include other functionality known in the arts. Any of the components of the workstation 912 may be placed in communication with the processing system 905 or any devices in communication therewith. Moreover, any of the modules and processing units of system 905 can be placed in communication with storage device 917 and/or computer media 913 and may store/retrieve therefrom data, variables, records, parameters, functions, and/or machine readable/executable program instructions, as needed to perform their intended functions.

Each of the modules of the processing system 905 may be placed in communication with one or more remote devices over network 918. It should be appreciated that some or all of the functionality performed by any of the modules or processing units of system 905 can be performed, in whole or in part, by the workstation 912 placed in communication with the handheld device 900 over network 918. The embodiment shown is illustrative and should not be viewed as limiting the scope of the appended claims strictly to that configuration. Various modules may designate one or more components which may, in turn, comprise software and/or hardware designed to perform the intended function.

### Various Embodiments

The teachings hereof can be implemented in hardware or software using any known or later developed systems, structures, devices, and/or software by those skilled in the applicable art without undue experimentation from the functional description provided herein with a general knowledge of the relevant arts. One or more aspects of the methods described herein are intended to be incorporated in an article of manufacture which may be shipped, sold, leased, or otherwise provided separately either alone or as part of a product suite or a service.

It will be appreciated that the above-disclosed and other features and functions, or alternatives thereof, may be desirably combined into other different systems or applications. Presently unforeseen or unanticipated alternatives, modifications, variations, or improvements may become apparent and/or subsequently made by those skilled in this art which are also intended to be encompassed by the following claims. The teachings of any publications referenced herein are each hereby incorporated by reference in their entirety.

What is claimed is:

1. A method for embedding a physiological signal into a video, comprising:
receiving a video of a subject;
receiving a time-varying signal corresponding to a physiological function of said subject;
obtaining a representative still image from said video;
replicating said representative image to generate a video sequence;
encoding segments of said received time-varying signal into said video sequence; and
compressing said video sequence using video compression.

2. The method of claim 1, wherein encoding signal segments comprises:
selecting at least one location in said obtained representative image wherein at least one signal segment is to be encoded; and
repeating for all signal segments:
encoding said signal segment into at least one patch of pixels; and
replacing original pixels in said obtained representative image at said selected location with said patch of pixels.

3. The method of claim 2, wherein encoding said signal segment into at least one patch of pixels comprises any of: spatial pixel replacement, manipulation of transform coefficients, and a barcode pattern.

4. The method of claim 2, wherein a length of said signal segment is based on a size of a neighborhood of pixels at said selected location.

5. The method of claim 2, wherein, in response to an identity of said subject being recognizable in said obtained representative image, said location being selected such that said identity is obscured by replacement of said original pixels with said pixel patches.

6. The method of claim 2, further comprising encoding values of said original pixels and their locations in an audio channel of said video sequence such that said original pixels are retained.

7. The method of claim 1, wherein said encoding signal segments comprises embedding said time-varying signal into an audio-channel of said video sequence.

8. The method of claim 1, wherein said obtained representative image is generated from multiple images obtained from said video.

9. The method of claim 1, wherein said video compression is one of: MPEG-4 and H.264 compression.

10. The method of claim 1, wherein, in advance of encoding said signal segments into said video sequence, constructing a synthetic signal from said time-varying signal, said synthetic signal being more highly compressible than said time-varying signal.

11. The method of claim 1, wherein, in advance of obtaining said representative image from said video, further comprising:
selecting an image which shows a facial area of said subject; and
extracting said facial area from said selected image.

12. The method of claim 1, wherein said time-varying signal corresponds to any of: a cardiac function, a respiratory function, a pulmonary volume, and a breathing pattern.

13. The method of claim 1, further comprising:
transforming said time-varying signal into an alternate domain; and
encoding segments of said transformed signal into said video sequence.

14. A system for embedding a physiological signal into a video, the system comprising:
a memory and a storage device; and
a processor in communication with said memory and storage device, said processor executing machine readable instructions for performing:
receiving a video of a subject;
receiving a time-varying signal corresponding to a physiological function of said subject;
obtaining a representative image from said video;
replicating said representative image to generate a video sequence;
encoding segments of said received time-varying signal into said video sequence; and
compressing said video sequence using video compression.

15. The system of claim 14, wherein encoding signal segments comprises:
selecting at least one location in said obtained representative image wherein at least one signal segment is to be encoded; and
repeating for all signal segments:
encoding said signal segment into at least one patch of pixels; and
replacing original pixels in said obtained representative image at said selected location with said patch of pixels.

16. The system of claim 15, wherein encoding said signal segment into at least one patch of pixels comprises any of: spatial pixel replacement, manipulation of DCT coefficients, and a barcode pattern.

17. The system of claim 15, wherein a length of said signal segment is based on a size of a neighborhood of pixels at said selected location.

18. The system of claim 15, wherein, in response to an identity of said subject being recognizable in said obtained representative image, said location being selected such that said identity is obscured by replacement of said original pixels with said pixel patches.

19. The system of claim 15, further comprising encoding values of said original pixels and their locations in an audio channel of said video sequence such that said original pixels are retained.

20. The system of claim 14, wherein said encoding signal segments comprises embedding said time-varying signal into an audio-channel of said video sequence.

21. The system of claim 14, wherein said obtained representative still image is generated from multiple images obtained from said video.

22. The system of claim 14, wherein said video compression is one of: MPEG-4 and H.264 compression.

23. The system of claim 14, wherein, in advance of encoding said signal segments into said video sequence, constructing a synthetic signal from said time-varying signal, said synthetic signal being more highly compressible than said time-varying signal.

24. The system of claim 14, wherein, in advance of obtaining said representative image from said video, further comprising:
selecting an image which shows a facial area of said subject; and
extracting said facial area from said selected image.

25. The system of claim 14, further comprising:
transforming said time-varying signal into an alternate domain; and
encoding segments of said transformed signal into said video sequence.
